(19) United States
(12) Patent Application Publication
(10) Pub. No.: US 2025/0224653 A1
(43) Pub. Date: Jul. 10, 2025

(54) ADAPTER AND IMAGING DEVICE

(71) Applicant: Sony Group Corporation, Tokyo (JP)

(72) Inventors: Yoshitaro SHIMOYAMA, Kanagawa (JP); Tomoyasu KATSUYAMA, Kanagawa (JP); Tatsuya YAMAZAKI, Kanagawa (JP)

(73) Assignee: Sony Group Corporation, Tokyo (JP)

(21) Appl. No.: 18/850,766

(22) PCT Filed: Apr. 10, 2023
(86) PCT No.: PCT/JP2023/014590

§ 371 Date: Sep. 25, 2024

(30) Foreign Application Priority Data
Apr. 20, 2022 (JP) 2022-069345

(51) Int. Cl. G03B 17/14; H04N 23/51; H04N 23/55

(52) U.S. Cl. CPC G03B 17/14; H04N 23/51; H04N 23/55

(57) ABSTRACT

An adapter includes an attachment unit that has one surface side to which an interchangeable lens having a lens-side engaging portion is attached, and the other surface side to which a device main body having a main-body-side engaging portion is attached. In the adapter, the attachment unit includes: a first positioning portion that is engaged with the lens-side engaging portion and performs positioning of the interchangeable lens at least in a perpendicular direction; and a second positioning portion that is engaged with the main-body-side engaging portion and performs positioning of the device main body at least in a horizontal direction, the position of the optical axis of the interchangeable lens is adjustable in the horizontal direction in a state in which the interchangeable lens is attached to the attachment unit, and the position of the optical axis of the device main body is adjustable in the perpendicular direction in a state in which the device main body is attached to the attachment unit.

### TECHNICAL FIELD

The present technology relates to a technical field of an adapter that enables a device main body to use different kinds of interchangeable lenses, and an imaging device including the adapter.

### BACKGROUND ART

In an imaging device such as a camera, an optical image of a subject captured by an optical system such as a lens is photoelectrically converted in an imaging element to generate an image or a video image.

Examples of such imaging devices include an imaging device in which an interchangeable lens and a device main body are attachable to and detachable from an adapter, and a desired type of interchangeable lens can be used in the device main body (see Patent Document 1, for example).

In the imaging device disclosed in Patent Document 1, an adapter is shown as a camera extension device, and an attachment unit is provided in the adapter. A light transmissive hole is formed in the attachment unit, an interchangeable lens is attached to one surface side of the attachment unit, and a device main body is attached to the other surface side.

In such an imaging device, an optical image of a subject captured by an optical system such as a lens disposed in the interchangeable lens passes through the light transmissive hole, enters an imaging element disposed inside the device main body, and is photoelectrically converted in the imaging element to generate an image and a video image.

### CITATION LIST

### Patent Document

Patent Document 1: Japanese Patent Application Laid-Open No. 2014-95785

### SUMMARY OF THE INVENTION

### Problems to be Solved by the Invention

Meanwhile, in an imaging device in which an interchangeable lens and a device main body are attached to an adapter as described above, there are cases where a deviation occurs between the optical axis of the interchangeable lens and the optical axis of the device main body (imaging element) due to machining tolerance of each component, errors in the attachment positions of the interchangeable lens and the device main body with respect to the adapter, or the like.

If such a deviation occurs between the optical axes, an image of the subject displayed on the display is displayed at a position deviated from the center of the display particularly in a case where zooming is performed to the telephoto side. Therefore, it is necessary to correct the imaging direction at the time of imaging, which might impair the user-friendliness of the imaging device.

In particular, in an imaging device with a high magnification, the shift of an image of the subject at the time of zooming to the telephoto side is remarkable, and the user-friendliness might be greatly impaired.

Therefore, it is desirable to adjust such an optical axis deviation between the interchangeable lens and the device main body. However, there is a demand for a highly convenient adjustment mechanism that takes into consideration the difference in weight between the interchangeable lens and the device main body, and the like.

Therefore, an adapter and an imaging device according to the present technology aims to ensure high convenience regarding adjustment of the optical axes of the interchangeable lens and the device main body.

### Solutions to Problems

An adapter according to the present technology includes an attachment unit that has one surface side to which an interchangeable lens having a lens-side engaging portion is attached, and the other surface side to which a device main body having a main-body-side engaging portion is attached. In the adapter, the attachment unit includes: a first positioning portion that is engaged with the lens-side engaging portion and performs positioning of the interchangeable lens at least in a perpendicular direction; and a second positioning portion that is engaged with the main-body-side engaging portion and performs positioning of the device main body at least in a horizontal direction, the position of the optical axis of the interchangeable lens is adjustable in the horizontal direction in a state in which the interchangeable lens is attached to the attachment unit, and the position of the optical axis of the device main body is adjustable in the perpendicular direction in a state in which the device main body is attached to the attachment unit.

Thus, the position of the optical axis of the interchangeable lens is adjustable in the horizontal direction in a state in which the interchangeable lens is positioned in the perpendicular direction by the first positioning portion, and the position of the optical axis of the device main body is adjustable in the perpendicular direction in a state in which the device main body is positioned in the horizontal direction by the second positioning portion.

An imaging device according to the present technology includes: an interchangeable lens including a lens-side engaging portion; a device main body including a main-body-side engaging portion; and an adapter including an attachment unit that has one surface side to which the interchangeable lens is attached, and the other surface side to which the device main body is attached. In the imaging device, the attachment unit includes: a first positioning portion that is engaged with the lens-side engaging portion and performs positioning of the interchangeable lens in a perpendicular direction; and a second positioning portion that is engaged with the main-body-side engaging portion and performs positioning of the device main body in a horizontal direction, the position of the optical axis of the interchangeable lens is adjustable in the horizontal direction in a state in which the interchangeable lens is attached to the attachment unit, and the position of the optical axis of the device main body is adjustable in the perpendicular direction in a state in which the device main body is attached to the attachment unit.

Thus, in the adapter, the position of the optical axis of the interchangeable lens is adjustable in the horizontal direction in a state in which the interchangeable lens is positioned in the perpendicular direction by the first positioning portion, and the position of the optical axis of the device main body is adjustable in the perpendicular direction in a state in which the device main body is positioned in the horizontal direction by the second positioning portion.

### BRIEF DESCRIPTION OF DRAWINGS

FIG. 1 illustrates an embodiment of the present technology together with FIGS. 2 to 12, and this drawing is a perspective view of an imaging device.

FIG. 2 is an exploded perspective view of the imaging device.

FIG. 3 is an enlarged perspective view illustrating a rear end portion of an interchangeable lens.

FIG. 4 is an enlarged perspective view illustrating a front end portion of a device main body.

FIG. 5 is an exploded perspective view illustrating a first slider and others in an adapter.

FIG. 6 is a front view of the adapter.

FIG. 7 is an exploded perspective view illustrating a second slider and others in the adapter.

FIG. 8 is a back view of the adapter.

FIG. 9 is a cross-sectional view illustrating a state in which the interchangeable lens is attached to an attachment unit.

FIG. 10 is a front view illustrating a state in which the position of the optical axis of the interchangeable lens has been adjusted, and the first slider has been moved in a horizontal direction.

FIG. 11 is a front view illustrating a state in which the position of the optical axis of the device main body has been adjusted, and the second slider has been moved in a perpendicular direction.

FIG. 12 is a block diagram of the imaging device.

### MODE FOR CARRYING OUT THE INVENTION

In the description below, a mode for embodying an adapter and an imaging device according to the present technology will be explained with reference to the accompanying drawings.

In the embodiment described below, an imaging device according to the present technology is applied to a video camera. However, the range of application of the present technology is not limited to video cameras. The present technology can be widely applied to various other kinds of imaging devices in which an interchangeable lens and a device main body are attachable to and detachable from an adapter.

In the following description, a longitudinal direction, a vertical direction, and a transverse direction are indicated as directions as seen from the operator during imaging with a video camera. Accordingly, when expressed on the basis of an optical axis extending through the center of the imaging element included in the video camera, the object side (subject) on the optical axis is the front side, and the image plane side on the optical axis is the rear side.

### Configuration of an Imaging Device

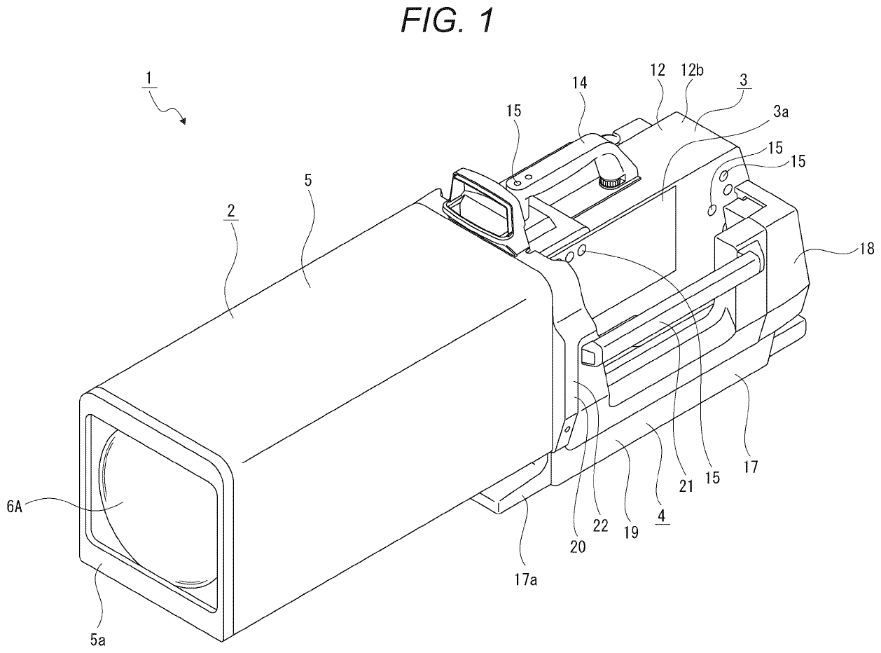

First, the configuration of an imaging device 1 is described (see FIGS. 1 to 9).

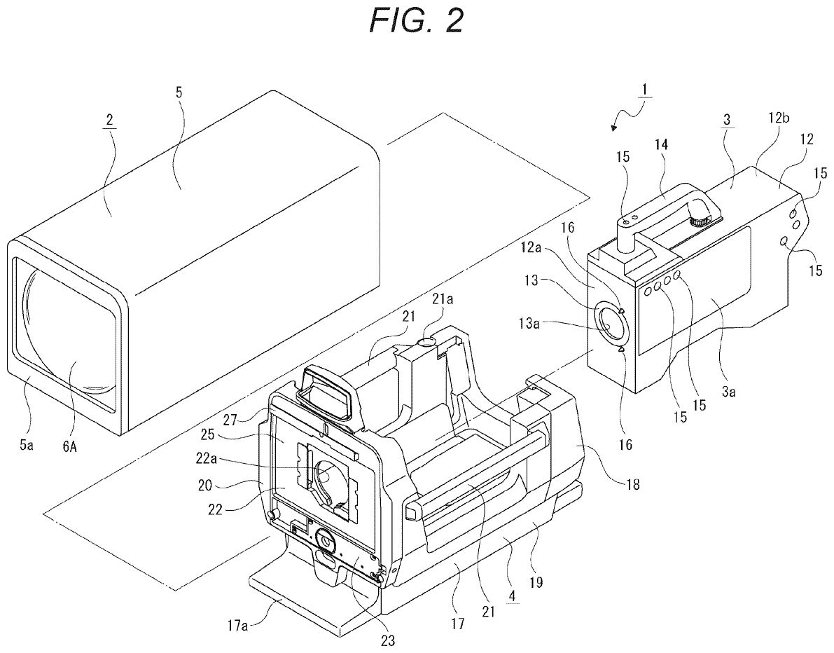

The imaging device 1 includes an interchangeable lens 2 having an optical system such as a lens, a device main body 3 in which an imaging element (not illustrated) is disposed, and an adapter 4 to which the interchangeable lens 2 and the device main body 3 can be detachably attached (see FIGS. 1 and 2).

The interchangeable lens 2 is of a large type with a high magnification, for example. The interchangeable lens 2 has a large number of lenses disposed therein, and its weight is large. Accordingly, the interchangeable lens 2 has a larger weight than the device main body 3.

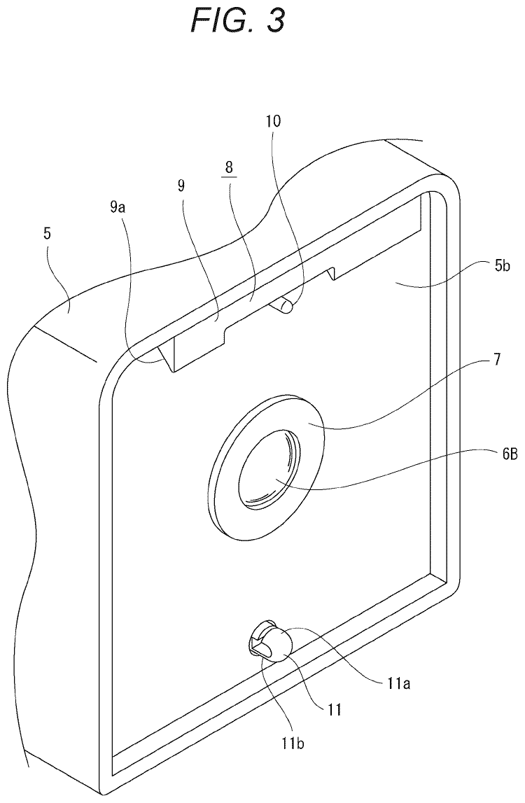

The interchangeable lens 2 includes an outer casing 5 formed in a box-like shape having a long length in the longitudinal direction, and an optical system including a plurality of lenses disposed in the outer casing 5 (see FIGS. 1 to 3). A lens 6A that is the first lens from the front side is disposed on a front face portion 5a of the outer casing 5, and a lens 6B that is the first lens from the rear side is disposed on a rear face portion 5b of the outer casing 5. The rear face portion 5b has an annular protruding portion 7 that protrudes rearward (see FIG. 3).

A first lens-side engaging portion 8 is attached to the outer casing 5 at a position closer to the upper end of the rear face portion 5b. The first lens-side engaging portion 8 includes a hook engaging portion 9 that extends in the transverse direction, and an engaging pin 10 that protrudes rearward from the lower end portion of the central portion of the hook engaging portion 9 in the transverse direction. The hook engaging portion 9 has an inclined surface 9a that has a substantially lower half portion formed in a downward protruding shape and is displaced more rearward at lower portions.

A second lens-side engaging portion 11 is attached to the outer casing 5 at a position closer to the lower end of the rear face portion 5b. The second lens-side engaging portion 11 is formed in a shaft-like shape that protrudes rearward, and its tip portion is formed in a substantially hemispherical shape that protrudes rearward. In the second lens-side engaging portion 11, a substantially upper half portion is provided as a deformable portion 11a, a substantially lower half portion is provided as a base 11b, and the deformable portion 11a is formed in a shape folded back with respect to the base 11b. The front end portion of the base 11b is attached to the outer casing 5, and the deformable portion 11a is designed not to continue to the outer casing 5. Accordingly, in the second lens-side engaging portion 11, the deformable portion 11a is elastically deformable in the substantially vertical direction in a narrow range with respect to the base 11b.

The device main body 3 includes a casing 12 provided as a case body, and the respective required portions including an imaging element disposed inside the casing 12 (see FIGS. 1, 2, and 4). The casing 12 is formed in a shape having a long length in the longitudinal direction, and a ring portion 13 is attached to a front face portion 12a. An inner opening of the ring portion 13 is formed as a light entrance hole 13a.

The device main body 3 is provided with an openable and closable display unit 3a having a display, and it is possible to check an image or a video image displayed by opening the display unit 3a at a time of imaging or the like. The device main body 3 is also provided with a viewfinder (not illustrated) on which an image or a video image can be checked at a rear end portion.

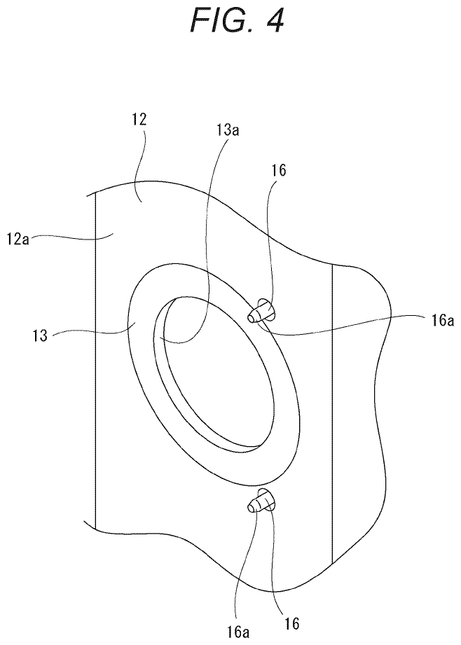

The device main body 3 is provided with a handle 14, and the handle 14 protrudes upward from an upper face portion 12b of the casing 12. In the device main body 3, a plurality of operation units 15 including an imaging button, a power button, and the like is disposed in the respective portions on the casing 12 and the handle 14. Two main-body-side engaging portions 16 positioned to be separated in the vertical direction are attached to the front face portion 12a of the casing 12 (see FIG. 4). The main-body-side engaging portions 16 are located around the ring portion 6, and are formed in a shaft-like shape protruding forward. The tip portions of the main-body-side engaging portions 16 are formed in a tapered shape, and are provided as guided portions 16a whose diameters are smaller at positions closer to the front end.

The adapter 4 includes a base holder 17 and a door unit 18. The base holder 17 includes a base portion 19 extending in substantially the vertical direction, an attachment unit 20 protruding upward from a position near the front end of the base portion 19, and two side portions 21 protruding upward from both the right and left end portions of the base portion 19, and a portion on the front side of the attachment unit 20 is provided as a receiving portion 17a. A rear end portion of one of the side portions 21 is provided as a hinge portion 21a, and the door unit 18 is rotatable (openable and closable), with the hinge portion 21a serving as the fulcrum.

When the door unit 18 is rotated to the open position, the device main body 3 can be inserted into a space between the side portions 21 from behind.

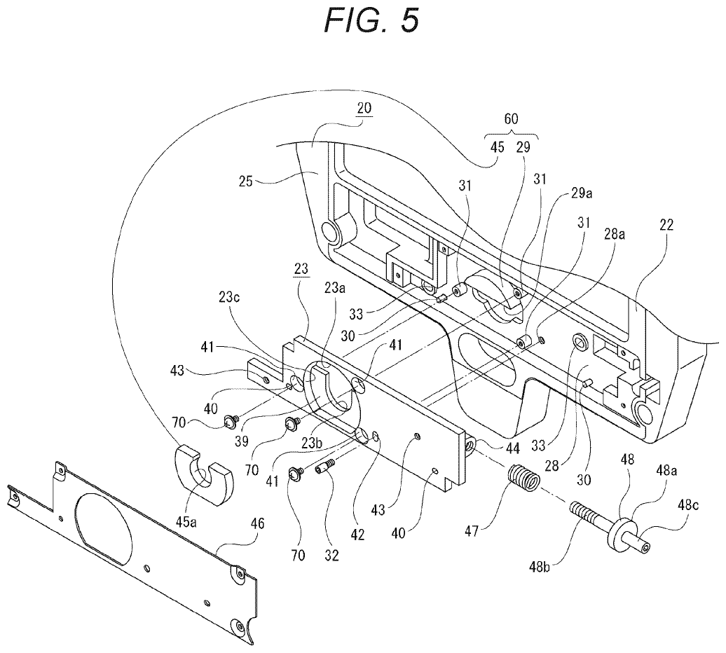

The attachment unit 20 includes a slider support unit 22, a first slider 23, and a second slider 24 (see FIGS. 5 to 8).

The slider support unit 22 is formed in a substantially thick plate-like shape extending in the longitudinal direction, and is a portion continuing to the base portion 19. A light transmissive hole 22a is formed in a substantially central portion of the slider support unit 22. The slider support unit 22 has a front surface formed as a lens-side attachment surface 25, and a rear surface formed as a main-body-side attachment surface 26.

A hanger 27 is attached to the slider support unit 22 at a position closer to the upper end on the side of the lens-side attachment surface 25. The hanger 27 is formed in a shape extending in the transverse direction, and has an inclined surface 27a in which a substantially upper half portion is formed in a shape protruding upward, and is displaced forward at upper portions. A positioning groove 27b that is open upward is formed in a middle portion of the hanger 27 in the transverse direction.

A first support portion 28 is formed in the slider support unit 22 (see FIG. 5). The first support portion 28 is formed at a lower end portion on the side of the lens-side attachment surface 25. A first screw hole 28a is formed in a middle portion of the first support portion 28 in the transverse direction.

A secured portion 29 is secured to a substantially central portion of the first support portion 28 in the transverse direction by screwing or the like. A lower edge of the secured portion 29 is formed as an engaging edge 29a extending in a horizontal direction.

In the first support portion 28, two first positioning pins 30 protruding forward are provided at a distance from each other in the transverse direction. The first support portion 28 is provided with a plurality of first attachment bosses 31 protruding forward. A first pilot screw 32 is screwed into the first screw hole 28a of the first support portion 28. In the first support portion 28, two first bolt insertion holes 33 are formed at a distance from each other in the transverse direction, and the first bolt insertion holes 33 are formed as elongated holes extending in the transverse direction.

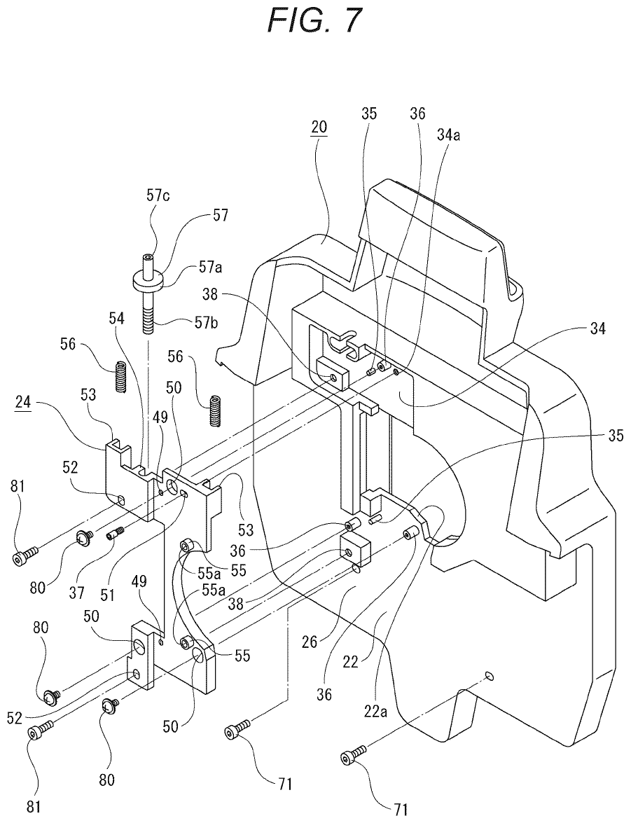

A second support portion 34 is formed in the slider support unit 22 (see FIG. 7). The second support portion 34 is formed in a portion extending from an obliquely left upper side to an obliquely left lower side of the light transmissive hole 22a on the side of the main-body-side attachment surface 26. A second screw hole 34a is formed at a position closer to the upper end of the second support portion 34.

In the second support portion 34, two second positioning pins 35 protruding rearward are provided at a distance from each other in the transverse direction. The second support portion 34 is provided with a plurality of second attachment bosses 36 protruding rearward. A second pilot screw 37 is screwed into the second screw hole 34a of the second support portion 34. In the second support portion 34, two second bolt screw holes 38 are formed at a distance from each other in the vertical direction.

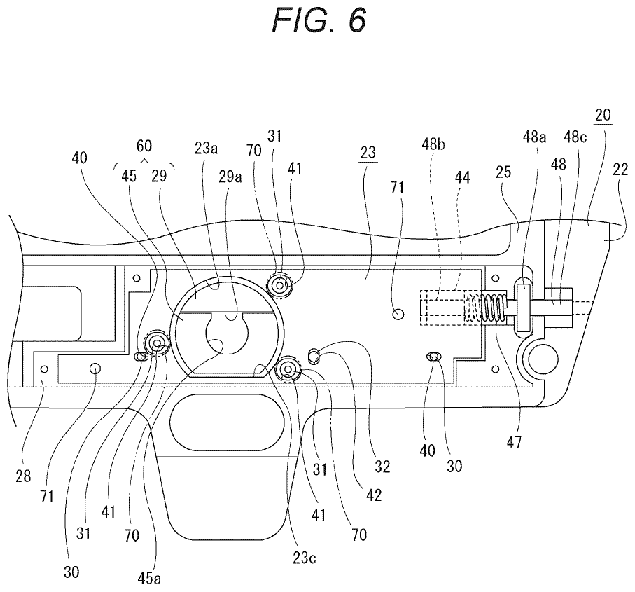

The first slider 23 is formed in a plate-like shape extending in the longitudinal direction, and is supported by the first support portion 28 so as to be movable in the horizontal direction (transverse direction) (see FIGS. 5 and 6).

In the first slider 23, a placement hole 23a and an insertion cutout 23b are formed continuously in the vertical direction. The placement hole 23a has the same shape as the secured portion 29, and is slightly larger than the secured portion 29. The insertion cutout 23b is open upward, and communicates with the placement hole 23a.

The first slider 23 has a substantially U-shaped attachment portion 39 whose thickness is smaller than other portions, and the attachment portion 39 is provided as a portion around the insertion cutout 23b. In the first slider 23, a placement recess 23c that is open forward is formed, and the attachment portion 39 is provided as a bottom surface portion of the placement recess 23c.

In the first slider 23, two first positioning holes 40 are formed at a distance from each other in the transverse direction, and the first positioning holes 40 are formed as elongated holes extending in the transverse direction. A plurality of first boss insertion holes 41 is formed in the first slider 23, and the first boss insertion holes 41 are formed as elongated holes extending in the transverse direction. A first screw insertion hole 42 is formed in the first slider 23, and the first screw insertion hole 42 is formed as an elongated hole extending vertically. In the first slider 23, two first bolt screw holes 43 are formed at a distance from each other in the transverse direction.

A first inserted portion 44 protruding rearward is provided at one end portion of the first slider 23 in the transverse direction. The first inserted portion 44 is formed in a substantially cylindrical shape whose axial direction is the transverse direction, for example, and has an inner peripheral surface formed as a screw portion.

A movable portion 45 is attached to the attachment portion 39 of the first slider 23 by screwing or the like. The movable portion 45 is formed in the same size and shape as the attachment portion 39, and has an insertion hole 45a penetrating in the longitudinal direction. The movable portion 45 and the secured portion 29 described above constitute a first positioning portion 60.

When the first positioning pins 30 of the first support portion 28 are inserted into the first positioning holes 40, the first slider 23 is supported movably in the horizontal direction (transverse direction) by the slider support unit 22 in a state in which the first slider 23 is positioned with respect to the slider support unit 22 in the vertical direction (perpendicular direction).

A cover plate 46 is attached to a lower end portion of the slider support unit 22 by screwing or the like, and the first slider 23 is covered with the cover plate 46 from the front.

In a state in which the first slider 23 is supported by the slider support unit 22, the secured portion 29 attached to the first support portion 28 is inserted into and disposed in the placement hole 23a. The lower surface of the secured portion 29 is positioned in proximity to or in contact with the upper surface of the movable portion 45. At this point of time, the respective first attachment bosses 31 provided in the first support portion 28 are inserted into the first boss insertion holes 41, and the first pilot screw 32 screwed into the first screw hole 28a of the first support portion 28 is inserted through the first screw insertion hole 42.

In a state in which the first slider 23 is supported by the slider support unit 22, part of a first adjustment screw 48 is inserted into the first inserted portion 44 via a first pushing spring 47 that is a compression coil spring, for example.

The first adjustment screw 48 includes a disk-shaped restricted portion 48a, a screw shaft portion 48b protruding to one side from a central portion of the restricted portion 48a, and an operated portion 48c protruding to the other side from the central portion of the restricted portion 48a. A hexagonal jig insertion hole into which a jig such as a hexagonal wrench is fitted is formed at a tip portion of the operated portion 48c, for example.

The first adjustment screw 48 is inserted into the first inserted portion 44 and is screwed into the screw portion in a state in which the screw shaft portion 48b is penetrated by the first pushing spring 47. The restricted portion 48a is then pushed in a direction away from the first inserted portion 44 by the first pushing spring 47. Accordingly, the first adjustment screw 48 is pressed against the screw portion of the first inserted portion 44 in the axial direction by the pushing force of the first pushing spring 47 so that the screw shaft portion 48b eliminates backlash.

The first adjustment screw 48 is not movable in the axial direction but is movable around the axis with respect to the slider support unit 22. Accordingly, when the first adjustment screw 48 is rotated by the jig inserted into the jig insertion hole, the screw portion of the first inserted portion 44 is sent to the screw shaft portion 48b, and the first slider 23 is moved to one side or the other side in the transverse direction with respect to the slider support unit 22, depending on the direction of rotation of the first adjustment screw 48.

The first slider 23, the first adjustment screw 48, the first pushing spring 47, and the like described above constitute a first adjustment mechanism that adjusts the position of the optical axis of the interchangeable lens 2.

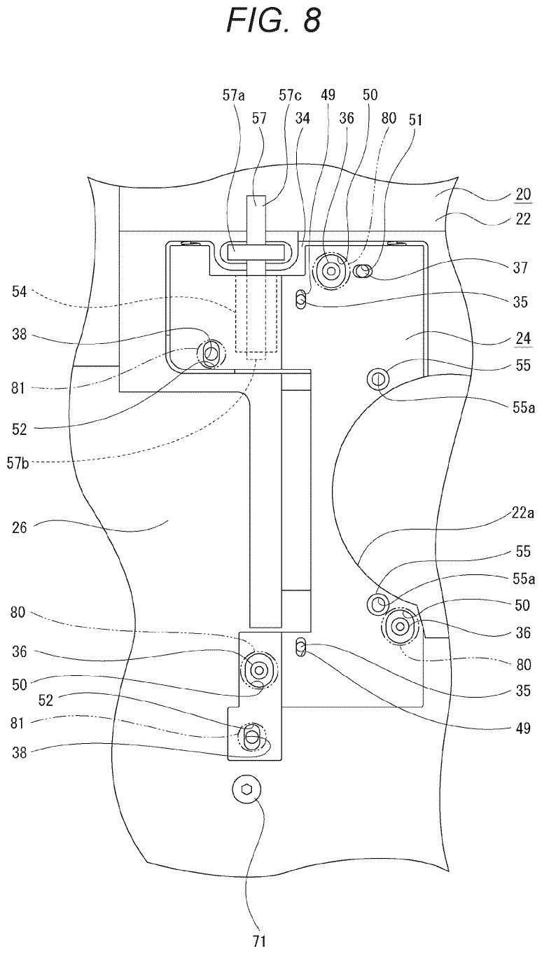

The second slider 24 is formed in a plate-like shape extending in the longitudinal direction, and is supported by the second support portion 34 so as to be movable in the perpendicular direction (vertical direction) (see FIGS. 7 and 8). The second slider 24 is supported above the portion in which the first slider 23 is located in the slider support unit 22, and exists at a position not overlapping the first slider 23 in the optical axis direction.

In the second slider 24, two second positioning holes 49 are formed at a distance from each other in the vertical direction, and the second positioning holes 49 are formed as elongated holes extending in the vertical direction. A plurality of second boss insertion holes 50 is formed in the second slider 24, and the second boss insertion holes 50 are formed as elongated holes extending in the vertical direction. A second screw insertion hole 51 is formed in the second slider 24, and the second screw insertion hole 51 is formed as an elongated hole extending in the transverse direction. In the second slider 24, two second bolt insertion holes 52 are formed at a distance from each other in the vertical direction, and the second bolt insertion holes 52 are formed as elongated holes extending in the vertical direction.

Two spring insertion portions 53 that are open at least upward are provided at an upper end portion of the second slider 24 so as to be separated from each other in the transverse direction.

A second inserted portion 54 protruding forward is provided at the upper end portion of the second slider 24. The second inserted portion 54 is formed in a substantially cylindrical shape whose axial direction is the vertical direction, for example, and has an inner peripheral surface formed as a screw portion.

In the second slider 24, two second positioning portions 55 protruding rearward are provided at a distance from each other in the vertical direction. Cone-shaped recesses 55a that are open forward are formed at the tip portions of the second positioning portions 55.

When the second positioning pins 35 of the second support portion 34 are inserted into the second positioning holes 49, the second slider 24 is supported movably in the vertical direction by the slider support unit 22 in a state in which the second slider 24 is positioned with respect to the slider support unit 22 in the transverse direction (horizontal direction).

In a state in which the second slider 24 is supported by the slider support unit 22, the second attachment bosses 36 provided on the second support portion 34 are inserted into the respective second boss insertion holes 50. At this point of time, the second pilot screw 37 screwed into the second screw hole 34a of the second support portion 34 is inserted through the second screw insertion hole 51.

In a state in which the second slider 24 is supported by the slider support unit 22, second pushing springs 56 that are compression coil springs are inserted into the respective spring insertion portions 53, for example, and the second slider 24 is pushed downward with respect to the slider support unit 22 by the second pushing springs 56. At this point of time, part of a second adjustment screw 57 is inserted into the second inserted portion 54.

The second adjustment screw 57 includes a disk-shaped restricted portion 57a, a screw shaft portion 57b protruding to one side from a central portion of the restricted portion 57a, and an operated portion 57c protruding to the other side from the central portion of the restricted portion 57a. A hexagonal jig insertion hole into which a jig such as a hexagonal wrench is fitted is formed at a tip portion of the operated portion 57c, for example.

The screw shaft portion 57b of the second adjustment screw 57 is inserted into the second inserted portion 54 and is screwed into the screw portion. At this point of time, the second slider 24 is pushed downward with respect to the slider support unit 22 by the second pushing springs 56. Accordingly, the second adjustment screw 57 is pressed against the screw portion of the second inserted portion 54 in the axial direction by the biasing force of the second pushing springs 56 so that the screw shaft portion 57b eliminates backlash.

The second adjustment screw 57 is not movable in the axial direction but is movable around the axis with respect to the slider support unit 22. Accordingly, when the second adjustment screw 57 is rotated by the jig inserted into the jig insertion hole, the screw portion of the second inserted portion 54 is sent to the screw shaft portion 57b, and the second slider 24 is moved to one side or the other side in the vertical direction with respect to the slider support unit 22, depending on the direction of rotation of the second adjustment screw 57.

The second slider 24, the second adjustment screw 57, the second pushing springs 56, and the like described above constitute a second adjustment mechanism that adjusts the position of the optical axis of the device main body 3.

In the imaging device 1 designed as described above, first attachment screws 70 are screwed into the respective first attachment bosses 31, to attach the first slider 23 to the first support portion 28. Second attachment screws 80 are screwed into the respective second attachment bosses 36, to attach the second slider 24 to the second support portion 34.

Further, in the imaging device 1, two first thread screws 71 and two second thread screws 81 are screwed into the first bolt screw holes 43 and the second bolt screw holes 38, respectively, from the rear side. The first thread screws 71 are inserted through the first bolt insertion holes 33 formed in the first support portion 28 and are screwed into the first bolt screw holes 43 formed in the first slider 23, and the second thread screws 81 are inserted through the second bolt insertion holes 52 formed in the second slider 24 and are screwed into the second bolt screw holes 38 formed in the second support portion 34.

### Attachment of the Interchangeable Lens and the Device Main Body to the Adapter

In the imaging device 1 designed as described above, the interchangeable lens 2 and the device main body 3 are attached to the attachment unit 20 of the adapter 4 in the following manner. The interchangeable lens 2 is attached to the attachment unit 20 on the side of the lens-side attachment surface 25, and the device main body 3 is attached to the attachment unit 20 on the side of the main-body-side attachment surface 26.

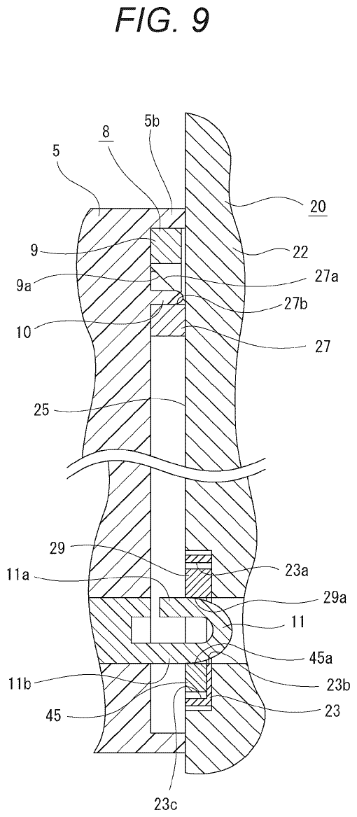

The interchangeable lens 2 is attached to the attachment unit 20, as the first lens-side engaging portion 8 and the second lens-side engaging portion 11 are engaged with the hanger 27 and the first positioning portion 60, respectively (see FIG. 9).

The first lens-side engaging portion 8 is engaged in a state in which the inclined surface 9a of the hook engaging portion 9 has surface contact with the inclined surface 27a of the hanger 27 from above, and the engaging pin 10 is inserted into the positioning groove 27b. As the inclined surface 9a of the hook engaging portion 9 is engaged with the inclined surface 27a of the hanger 27, the heavy interchangeable lens 2 is supported by the hanger 27. As the engaging pin 10 is inserted into the positioning groove 27b, the interchangeable lens 2 is positioned in the transverse direction with respect to the attachment unit 20.

At this point of time, the second lens-side engaging portion 11 is inserted sequentially through the insertion hole 45a of the movable portion 45 and the insertion cutout 23b of the first slider 23, and the upper surface of the deformable portion 11a is brought into contact with the engaging edge 29a of the secured portion 29. In the imaging device 1, the dimensions of the respective portions are set so that the upper end of the second lens-side engaging portion 11 is located about several um to 10 um above the engaging edge 29a when the second lens-side engaging portion 11 is inserted through the insertion hole 45a in a state in which the first lens-side engaging portion 8 is engaged with the hanger 27. Accordingly, the second lens-side engaging portion 11 is engaged with the engaging edge 29a in a state in which the deformable portion 11a is slightly elastically deformed, and the interchangeable lens 2 is positioned with high accuracy in the vertical direction with respect to the attachment unit 20.

As the deformable portion 11a being slightly elastically deformed is engaged with the engaging edge 29a, high positional accuracy in the vertical direction with respect to the attachment unit 20 of the interchangeable lens 2 is ensured, and the interchangeable lens 2 is stably attached to the attachment unit 20 without rattling.

Meanwhile, the attachment of the device main body 3 to the attachment unit 20 is performed by inserting the device main body 3 between the pair of side portions 21 from the rear in a state in which the door unit 18 of the adapter 4 is open, and inserting and engaging the two main-body-side engaging portions 16 into and with the second positioning portions 55. In the main-body-side engaging portions 16, the guided portions 16a are fitted into the recesses 55a. Therefore, the device main body 3 is positioned on the attachment unit 20 with high precision.

In a state in which the main-body-side engaging portions 16 are engaged with the second positioning portions 55, the door unit 18 is closed, and the device main body 3 is pressed by the door unit 18 from the rear side, and is held by the adapter 4.

In a state in which the interchangeable lens 2 and the device main body 3 are attached to the adapter 4 as described above, the protruding portion 7 of the interchangeable lens 2 and the ring portion 13 of the device main body 3 are positioned, with the light transmissive hole 22a formed in the adapter 4 being interposed in between. Accordingly, an optical image of the subject captured by the optical system of the interchangeable lens 2 can enter the imaging element disposed inside the device main body 3 through the light transmissive hole 22a.

### Optical Axis Adjustment Operation in the Interchangeable Lens and the Device Main Body

Next, an operation to be performed to adjust the optical axis of the interchangeable lens 2 and the optical axis of the device main body 3 is described (see FIGS. 6, 8, 10, and 11). Note that, specifically, the operation to adjust the optical axis of the device main body 3 corresponds to an operation to adjust the optical axis of the imaging element. In particular, the optical axis extending through the center of the imaging element in the device main body 3, and the optical axis of the interchangeable lens 2 are adjusted.

In the imaging device 1, the optical axis position adjustment for the interchangeable lens 2 in the horizontal direction and the optical axis position adjustment for the device main body 3 in the perpendicular direction can be performed, the optical axis position adjustment of the interchangeable lens 2 is performed in a state in which the interchangeable lens 2 is attached to the attachment unit 20, and the optical axis position adjustment of the device main body 3 is performed in a state in which the device main body 3 is attached to the attachment unit 20.

In a state before the optical axis position adjustment is performed on the optical axes of the interchangeable lens 2 and the device main body 3, the first pilot screw 32 and the second pilot screw 37 are removed from the first screw hole 28a of the first support portion 28 and the second screw hole 34a of the second support portion 34, respectively, and the first pilot screw 32 and the second pilot screw 37 are pulled out from the first screw insertion hole 42 and the second screw insertion hole 51, respectively, so that the optical axis position adjustment can be performed on the interchangeable lens 2 and the device main body 3.

Further, before the optical axis position adjustment is performed on the interchangeable lens 2 and the device main body 3, each of the two first thread screws 71 and the two second thread screws 81 is loosened from the rear side, and the respective screwed states of the first bolt screw holes 43 and the second bolt screw holes 38 are cancelled. The screwed states of the first thread screws 71 and the second thread screws 81 are both cancelled from the rear side in this manner, and preparation for the position adjustment of the optical axes of the interchangeable lens 2 and the device main body 3 is performed. Thus, the preparation operation for the position adjustment of the optical axes can be quickly and easily performed.

When the preparation operation as described above is completed, the operation to adjust the optical axis of the interchangeable lens 2 and the optical axis of the device main body 3 are performed.

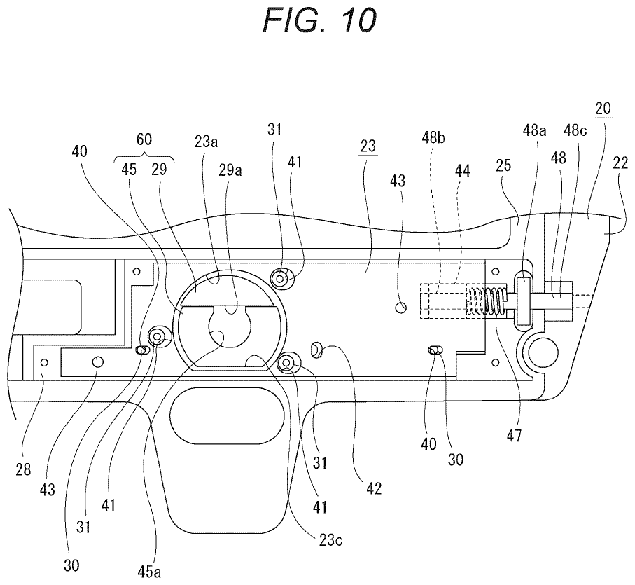

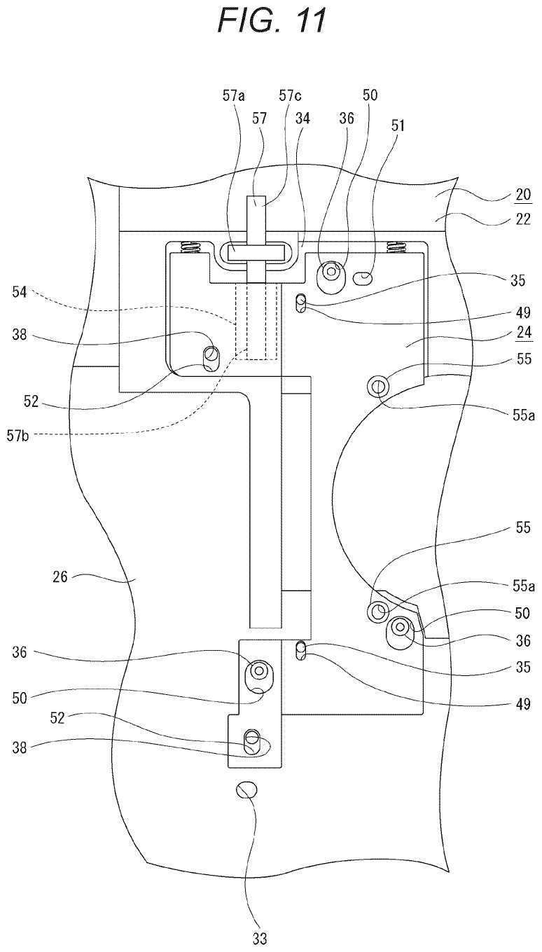

At the time of the adjustment operation, a center marker and a test chart such as the Siemens star chart are displayed on the viewfinder, for example, and the first slider 23 is moved in the horizontal direction and the second slider 24 is moved in the perpendicular direction so that the center marker and the center of the test chart coincide with each other (see FIGS. 10 and 11). When the first slider 23 is moved in the horizontal direction, the interchangeable lens 2 positioned by the first positioning portion 60 is moved (displaced) in the horizontal direction with respect to the slider support unit 22 along with the movement of the first slider 23.

Also, when the second slider 24 is moved, the device main body 3 positioned by the second positioning portions 55 is moved (displaced) in the perpendicular direction with respect to the slider support unit 22 along with the movement of the second slider 24.

The movement of the first slider 23 in the horizontal direction can be conducted by rotating the first adjustment screw 48 to one side or the other side with a jig, and the movement of the second slider 24 in the perpendicular direction can be conducted by rotating the second adjustment screw 57 to one side or the other side with a jig. Note that, in the imaging device 1, the amount of optical axis adjustment is set to a range of about 0.4 mm at the maximum, for example, in both the horizontal direction and the perpendicular direction. However, the amount of optical axis adjustment may be set to any range, and the amount of adjustment in the horizontal direction and the amount of adjustment in the perpendicular direction may be set to different ranges.

In the adjustment operation, the first slider 23 is moved in the horizontal direction and the second slider 24 is moved in the perpendicular direction so that the center marker coincides with the center of the test chart between the wide-angle end and the telephoto end. In particular, it is desirable to perform adjustment so that the center marker and the center of the test chart coincide with each other at the telephoto end.

In a state in which the optical axis position adjustment operation has been completed in the interchangeable lens 2 and the device main body 3, the two first thread screws 71 and the two second thread screws 81 are screwed into the first bolt screw holes 43 and the second bolt screw holes 38, respectively, from the rear side. In a state in which the first thread screws 71 are screwed into the first bolt screw holes 43, the first thread screws 71 are inserted through the first bolt insertion holes 33 formed in the first support portion 28. In a state in which the second thread screws 81 are screwed into the first bolt screw holes 43, the second thread screws 81 are inserted through the second bolt insertion holes 52 formed in the second slider 24.

### Summary

As described above, in the adapter 4 and the imaging device 1, the first positioning portion 60 that performs positioning of the interchangeable lens 2 at least in the perpendicular direction, and the second positioning portions 55 that perform positioning of the device main body 3 at least in the horizontal direction are provided, the position of the optical axis of the interchangeable lens 2 is adjustable in the horizontal direction, and the position of the optical axis of the device main body 3 is adjustable in the perpendicular direction.

Accordingly, the position of the optical axis of the interchangeable lens 2 is adjustable in the horizontal direction in a state in which the interchangeable lens 2 is positioned in the perpendicular direction by the first positioning portion 60, and the position of the optical axis of the device main body 3 is adjustable in the perpendicular direction in a state in which the device main body 3 is positioned in the horizontal direction by the second positioning portions 55. With this arrangement, the adjustment of the optical axis of the interchangeable lens 2 and the adjustment of the optical axis of the device main body 3 are performed in one direction at a time in directions orthogonal to each other. Thus, it is possible to ensure high convenience regarding the adjustment of the optical axes of the interchangeable lens 2 and the device main body 3.

In particular, when the interchangeable lens 2 heavier than the device main body 3 is displaced upward against gravity, a high load is likely to be applied onto the adjustment mechanism. However, as the adjustment of the interchangeable lens 2 is performed in the horizontal direction, the optical axes of the interchangeable lens 2 and the device main body 3 can be appropriately adjusted, without application of an excessive load onto the adjustment mechanism.

Further, the position of the optical axis of the interchangeable lens 2 can be adjusted by the interchangeable lens 2 being displaced in the horizontal direction with respect to the attachment unit 20, and the position of the optical axis of the device main body 3 can be adjusted by the device main body 3 being displaced in the perpendicular direction with respect to the attachment unit 20.

Accordingly, displacement of the interchangeable lens 2 and displacement of the device main body 3 are based on the same portion. Thus, the optical axis of the interchangeable lens 2 and the optical axis of the device main body 3 can be easily and accurately matched.

Moreover, the first slider 23 supported by one surface of the slider support unit 22 in the thickness direction, and the second slider 24 supported by the other surface of the slider support unit 22 in the thickness direction are provided at positions not overlapping each other in the optical axis direction.

Accordingly, the first slider 23 and the second slider 24 are not supported by the same portion of the slider support unit 22. Thus, the thickness of the slider support unit 22 does not become excessively thinner, a thickness equal to or greater than a certain value is ensured for the slider support unit 22, a high strength of the attachment unit 20 is ensured, and a stable attached state of the interchangeable lens 2 and the device main body 3 with respect to the attachment unit 20 can be ensured.

Furthermore, it is possible to appropriately adjust the positions of the optical axis of the interchangeable lens 2 and the optical axis of the device main body 3, after ensuring a one-touch attached state of the device main body 3 to the adapter 4 and ensuring a holding strength for the interchangeable lens 2 having a large weight in the attachment unit 20.

Further, the first positioning portion 60 includes the secured portion 29 that is secured to the slider support unit 22, and the movable portion 45 that is moved integrally with the first slider 23. The first slider 23 is moved with respect to the slider support unit 22 in a state in which the second lens-side engaging portion 11 is engaged with the engaging edge 29a.

Accordingly, the first slider 23 is moved in a state in which the position of the interchangeable lens 2 in the perpendicular direction is maintained. Thus, the position of the optical axis of the interchangeable lens 2 can be easily and reliably adjusted.

Furthermore, the adapter 4 includes the first adjustment screw 48 screwed to the first slider 23, and the first slider 23 is moved when the first adjustment screw 48 is rotated.

Accordingly, the position of the optical axis of the interchangeable lens 2 is changed in accordance with the direction of rotation and the amount of rotation of the first adjustment screw 48. Thus, the position of the optical axis of the interchangeable lens 2 can be easily adjusted. In particular, neither a large-scale adjustment operation nor a repetitive try-and-error adjustment operation needs to be performed, and it is possible to adjust the position of the optical axis of the device main body 3 with a single jig that rotates the first adjustment screw 48. Even in a case where the interchangeable lens 2 or the device main body 3 attached to the adapter 4 is changed, the adjustment can be easily performed each time the interchangeable lens 2 or the device main body 3 is replaced.

Moreover, since the first pushing spring 47 that pushes the first adjustment screw 48 in the axial direction is provided, the screw groove of the first adjustment screw 48 is pressed against the screw portion of the first slider 23 by the pushing force of the first pushing spring 47, the position of the first adjustment screw 48 in the axial direction is not unintentionally changed due to the presence of backlash, and the position of the optical axis of the interchangeable lens 2 can be adjusted with high precision.

Furthermore, the second adjustment screw 57 screwed to the second slider 24 is provided, and the second slider 24 is moved when the second adjustment screw 57 is rotated.

Accordingly, the position of the optical axis of the device main body 3 is changed in accordance with the direction of rotation and the amount of rotation of the second adjustment screw 57. Thus, the position of the optical axis of the device main body 3 can be easily adjusted. In particular, neither a large-scale adjustment operation nor a repetitive try-and-error adjustment operation needs to be performed, and it is possible to adjust the position of the optical axis of the device main body 3 with a single jig that rotates the second adjustment screw 57. Even in a case where the interchangeable lens 2 or the device main body 3 attached to the adapter 4 is changed, the adjustment can be easily performed each time the interchangeable lens 2 or the device main body 3 is replaced.

In addition to that, since the second pushing springs 56 that push the second adjustment screw 57 in the axial direction is provided, the screw groove of the second adjustment screw 57 is pressed against the screw portion of the second slider 24 by the pushing force of the second pushing springs 56, the position of the second adjustment screw 57 in the axial direction is not unintentionally changed due to the presence of backlash, and the position of the optical axis of the device main body 3 can be adjusted with high precision.

### One Embodiment of the Imaging Device

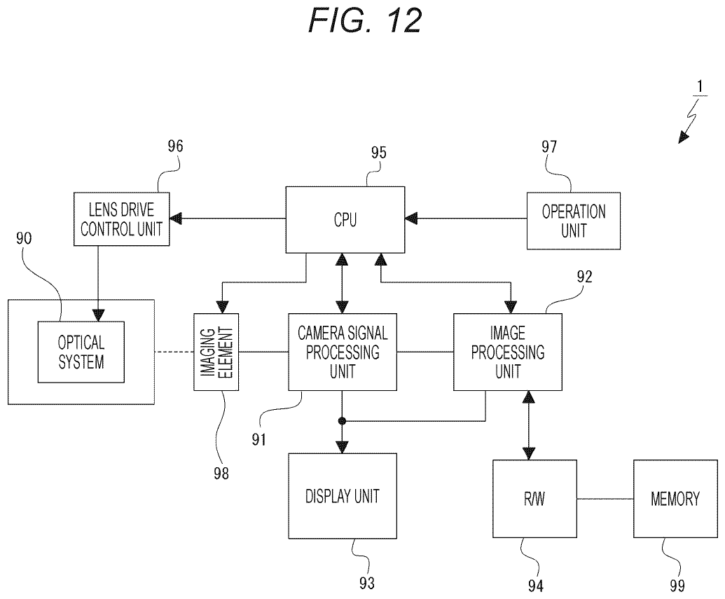

In the description below, an example configuration of an embodiment of the imaging device 1 is explained (see FIG. 12).

The imaging device 1 includes an interchangeable lens 2 having an optical system 90, and a device main body 3 light is to enter via the optical system 90.

The imaging device 1 includes: a camera signal processing unit 91 that performs signal processing such as analog-digital conversion of a captured image signal; and an image processing unit 92 that performs a recording/reproducing process on the image signal. Also, the imaging device 1 includes: a display unit 93 (display unit 3a) that displays a captured image and the like; a reader/writer (R/W) 94 that writes and reads an image signal into and from a memory 99; a central processing unit (CPU) 95 that controls the entire imaging device 1; a lens drive control unit 96 that controls driving of the lens disposed in the optical system 90; and an operation unit 97 (operation units 15) such as various switches on which a user performs required operations.

The imaging device 1 is provided with an imaging element 98 such as a CCD or a CMOS that converts an optical image captured by the optical system 90 into an electrical signal.

The camera signal processing unit 91 performs various kinds of signal processing such as conversion of an output signal from the imaging element 98 into a digital signal, noise removal, image quality correction, and conversion into a luminance/color difference signal.

The image processing unit 92 performs a compression encoding/decompression decoding process on an image signal based on a predetermined image data format, a conversion process on data specification such as resolution, and the like.

The display unit 93 has a function of displaying various kinds of data such as an operating state of the user on the operation unit 97 and a captured image. Note that the imaging device 1 may not be provided with the display unit 93, and may be designed so that captured image data is sent to another display device, and the image is displayed.

The R/W 94 writes image data encoded by the image processing unit 92 into the memory 99, and reads image data recorded in the memory 99.

The CPU 95 serves as a control processing unit that controls each circuit block provided in the imaging device 1, and controls each circuit block on the basis of an instruction input signal or the like from the operation unit 97.

The lens drive control unit 96 controls a drive source that moves the lens on the basis of a control signal from the CPU 95.

The operation unit 97 outputs an instruction input signal in accordance with the user operation, to the CPU 95.

The memory 99 is a semiconductor memory attachable to and detachable from a slot connected to the R/W 94, or a semiconductor memory incorporated beforehand into the imaging device 1, for example.

An operation in the imaging device 1 is described below.

In a standby state for imaging, under the control of the CPU 95, a captured image signal is output to the display unit 93 via the camera signal processing unit 91, and is displayed as a through-the-camera image. Furthermore, when an instruction input signal from the operation unit 97 is input, the CPU 95 outputs a control signal to the lens drive control unit 96, and the lens is moved on the basis of the control performed by the lens drive control unit 96.

When an imaging operation is performed in accordance with the instruction input signal from the operation unit 97, a captured image signal is output from the camera signal processing unit 91 to the image processing unit 92, is subjected to a compression encoding process, and is converted into digital data in a predetermined data format. The converted data is output to the R/W 94, and is written into the memory 99.

In a case where the image data recorded in the memory 99 is reproduced, predetermined image data is read from the memory 99 by the R/W 94 in response to an operation performed on the operation unit 97, and a decompression decoding process is performed by the image processing unit 92. After that, a reproduced image signal is output to the display unit 93, and a reproduced image is displayed.

Note that, in the present technology, the term “imaging” refers to processing including only some of or all of a series of processes starting from a photoelectric conversion process of converting captured light into an electrical signal by the imaging element 98, processing such as conversion of the output signal from the imaging element 98 into a digital signal, noise removal, image quality correction, and conversion into a luminance/color difference signal by the camera signal processing unit 91, a compression encoding/decompression decoding process for an image signal based on a predetermined image data format, and a process of converting the data specification such as the resolution by the image processing unit 92, till a process of writing the image signal into the memory 99 by the R/W 94.

That is, the term “imaging” may refer only to the photoelectric conversion process of converting captured light into an electrical signal by the imaging element 98, or may refer to the processing from the photoelectric conversion process of converting captured light into an electrical signal by the imaging element 98 till the processing such as the conversion of the output signal from the imaging element 98 into a digital signal, noise removal, image quality correction, and conversion into a luminance/color difference signal by the camera signal processing unit 91. Also, the term “imaging” may refer to the processing from the photoelectric conversion process of converting captured light into an electrical signal by the imaging element 98 till the compression encoding/decompression decoding process for an image signal based on a predetermined image data format by the image processing unit 92 and the process of converting the data specification such as the resolution, through the processing such as conversion of the output signal from the imaging element 98 into a digital signal, noise removal, image quality correction, and conversion into a luminance/color difference signal by the camera signal processing unit 91. Further, the term “imaging” may refer to the processing from the photoelectric conversion process of converting captured light into an electrical signal by the imaging element 98, and the processing such as conversion of the output signal from the imaging element 98 into a digital signal, noise removal, image quality correction, and conversion into a luminance/color difference signal by the camera signal processing unit 91, till the compression encoding/decompression decoding process for an image signal based on a predetermined image data format and the process of converting the data specification such as the resolution by the image processing unit 92, or may refer to the processing until the process of writing an image signal into the memory 99 by the R/W 94.

In the above-described processing, the order of the respective processes may be changed as appropriate.

Furthermore, in the present technology, the optical system 90 and the imaging device 1 may include only some of or all of the imaging element 98, the camera signal processing unit 91, the image processing unit 92, and the R/W 94 that perform the above-described processing.

Moreover, the optical system 90 may include some of the imaging element 98, the camera signal processing unit 91, the image processing unit 92, and the R/W 94.

### Present Technology The present technology may also be configured as described below.

(1)

An adapter including
an attachment unit that has one surface side to which an interchangeable lens having a lens-side engaging portion is attached, and another surface side to which a device main body having a main-body-side engaging portion is attached,
in which
the attachment unit includes: a first positioning portion that is engaged with the lens-side engaging portion and performs positioning of the interchangeable lens at least in a perpendicular direction; and a second positioning portion that is engaged with the main-body-side engaging portion and performs positioning of the device main body at least in a horizontal direction,
a position of an optical axis of the interchangeable lens is adjustable in the horizontal direction in a state in which the interchangeable lens is attached to the attachment unit, and
a position of an optical axis of the device main body is adjustable in the perpendicular direction in a state in which the device main body is attached to the attachment unit.

(2)

The adapter according to (1), in which
the position of the optical axis of the interchangeable lens is adjustable by displacing the interchangeable lens in the horizontal direction with respect to the attachment unit, and
the position of the optical axis of the device main body is adjustable by displacing the device main body in the perpendicular direction with respect to the attachment unit.

(3)

The adapter according to (2), in which
a slider support unit is provided in the attachment unit,
a first slider movable in the horizontal direction is supported by one surface of the slider support unit in a thickness direction,
a second slider movable in the perpendicular direction is supported by another surface of the slider support unit in the thickness direction,
the interchangeable lens is displaced in the horizontal direction along with movement of the first slider,
the device main body is displaced in the perpendicular direction along with movement of the second slider, and
the first slider and the second slider are disposed at positions not overlapping each other in an optical axis direction.

(4)

The adapter according to (3), in which
the first positioning portion includes a secured portion that is secured to the slider support unit, and a movable portion that is attached to the first slider and is moved integrally with the first slider,
an engaging edge extending in the horizontal direction is formed on the secured portion,
an insertion hole is formed in the movable portion, and
the first slider is moved with respect to the slider support unit in a state in which the lens-side engaging portion is inserted through the insertion hole and is engaged with the engaging edge.

(5)

The adapter according to (3) or (4), in which
a first adjustment screw screwed into the first slider is provided, and
the first adjustment screw is rotated, to move the first slider.

(6)

The adapter according to (5), in which
a first pushing spring that pushes the first adjustment screw in an axial direction is provided.

(7)

The adapter according to (3) or (4), in which
a second adjustment screw screwed into the second slider is provided, and
the second adjustment screw is rotated, to move the second slider.

(8)

The adapter according to (7), in which
a second pushing spring that pushes the second adjustment screw in an axial direction is provided.

(9)
An imaging device including:
an interchangeable lens including a lens-side engaging portion;
a device main body including a main-body-side engaging portion; and
an adapter including an attachment unit that has one surface side to which the interchangeable lens is attached, and another surface side to which the device main body is attached,
in which
the attachment unit includes: a first positioning portion that is engaged with the lens-side engaging portion and performs positioning of the interchangeable lens in a perpendicular direction; and a second positioning portion that is engaged with the main-body-side engaging portion and performs positioning of the device main body in a horizontal direction,
a position of an optical axis of the interchangeable lens is adjustable in the horizontal direction in a state in which the interchangeable lens is attached to the attachment unit, and
a position of an optical axis of the device main body is adjustable in the perpendicular direction in a state in which the device main body is attached to the attachment unit.

### REFERENCE SIGNS LIST

1 Imaging device
2 Interchangeable lens
3 Device main body
4 Adapter
20 Attachment unit
22 Slider support unit
23 First slider
24 Second slider
25 Lens-side attachment surface
26 Main-body-side attachment surface
29 Secured portion
29a Engaging edge
45 Movable portion
45a Insertion hole
47 First pushing spring
48 First adjustment screw
55 Second positioning portion
56 second pushing spring
57 Second adjustment screw
60 First positioning portion

1. An adapter comprising
an attachment unit that has one surface side to which an interchangeable lens having a lens-side engaging portion is attached, and another surface side to which a device main body having a main-body-side engaging portion is attached,
wherein
the attachment unit includes: a first positioning portion that is engaged with the lens-side engaging portion and performs positioning of the interchangeable lens at least in a perpendicular direction; and a second positioning portion that is engaged with the main-body-side engaging portion and performs positioning of the device main body at least in a horizontal direction,
a position of an optical axis of the interchangeable lens is adjustable in the horizontal direction in a state in which the interchangeable lens is attached to the attachment unit, and
a position of an optical axis of the device main body is adjustable in the perpendicular direction in a state in which the device main body is attached to the attachment unit.

2. The adapter according to claim 1, wherein
the position of the optical axis of the interchangeable lens is adjustable by displacing the interchangeable lens in the horizontal direction with respect to the attachment unit, and
the position of the optical axis of the device main body is adjustable by displacing the device main body in the perpendicular direction with respect to the attachment unit.

3. The adapter according to claim 2, wherein
a slider support unit is provided in the attachment unit,
a first slider movable in the horizontal direction is supported by one surface of the slider support unit in a thickness direction,
a second slider movable in the perpendicular direction is supported by another surface of the slider support unit in the thickness direction,
the interchangeable lens is displaced in the horizontal direction along with movement of the first slider,
the device main body is displaced in the perpendicular direction along with movement of the second slider, and
the first slider and the second slider are disposed at positions not overlapping each other in an optical axis direction.

4. The adapter according to claim 3, wherein
the first positioning portion includes a secured portion that is secured to the slider support unit, and a movable portion that is attached to the first slider and is moved integrally with the first slider,
an engaging edge extending in the horizontal direction is formed on the secured portion,
an insertion hole is formed in the movable portion, and
the first slider is moved with respect to the slider support unit in a state in which the lens-side engaging portion is inserted through the insertion hole and is engaged with the engaging edge.

5. The adapter according to claim 3, wherein
a first adjustment screw screwed into the first slider is provided, and
the first adjustment screw is rotated, to move the first slider.

6. The adapter according to claim 5, wherein
a first pushing spring that pushes the first adjustment screw in an axial direction is provided.

7. The adapter according to claim 3, wherein
a second adjustment screw screwed into the second slider is provided, and
the second adjustment screw is rotated, to move the second slider.

8. The adapter according to claim 7, wherein
a second pushing spring that pushes the second adjustment screw in an axial direction is provided.

9. An imaging device comprising:
an interchangeable lens including a lens-side engaging portion;
a device main body including a main-body-side engaging portion; and
an adapter including an attachment unit that has one surface side to which the interchangeable lens is attached, and another surface side to which the device main body is attached,
wherein
the attachment unit includes: a first positioning portion that is engaged with the lens-side engaging portion and performs positioning of the interchangeable lens in a perpendicular direction; and a second positioning portion that is engaged with the main-body-side engaging portion and performs positioning of the device main body in a horizontal direction,
a position of an optical axis of the interchangeable lens is adjustable in the horizontal direction in a state in which the interchangeable lens is attached to the attachment unit, and
a position of an optical axis of the device main body is adjustable in the perpendicular direction in a state in which the device main body is attached to the attachment unit.
